(19) United States
(12) Patent Application Publication
(10) Pub. No.: US 2011/0133659 A1
(43) Pub. Date: Jun. 9, 2011

(54) Power Source Control Method for a Multi-module LED Circuit and Related Control Device and LED Circuit

(76) Inventors: Jian-Shen Li, Taipei County (TW); Chun-Liang Lin, Taichung City (TW)

(21) Appl. No.: 12/631,852

(22) Filed: Dec. 6, 2009

(51) Int. Cl. H05B 39/00

(52) U.S. Cl. 315/193

(57) ABSTRACT

A power source control method for a multi-module light-emitting diode (LED) circuit includes detecting a signal characteristics value according to a plurality of switching signals, being used for controlling the conduction of currents in the plurality of lighting modules, comparing the signal characteristics value with a pre-determined value to generate a comparing result, and outputting the comparing result to an external power supply device, such that the external power supply device can adjust the voltage level of an input voltage of the multi-module LED circuit according to the comparing result.

### BACKGROUND OF THE INVENTION

1. Field of the Invention

The present invention is related to a power source control method for a multi-module light-emitting diode (LED) circuit, and related control device and LED circuit, and more particularly, to a power source control method which can adjust the input voltage of the LED circuit to advance the power efficiency of the LED circuit, and related control device and LED circuit.

2. Description of the Prior Art

The applications of the light-emitting diode (LED) device are getting more popular; many examples can be seen in everyday life; for example, the large-scale outdoor TV, the traffic light, the backlight of the liquid-crystal display (LCD) device, the lighting devices of bicycle . . . etc. Utilizing the LED devices to build outdoor lights may include hundreds or thousands of small LED devices generating light together, and the luminous uniformity among different LED devices becomes an important technical issue and can greatly affect the quality of the lights. Besides the luminous uniformity, the power efficiency of the LED lights is also an important issue; if the power efficiency can be improved, vast amount of energy can be saved. Today, the LED devices are usually connected in series to become an lighting module, and two or more lighting modules are connected in parallel to become a LED circuit; to make every LED device in the LED circuit work with balanced current (balanced current implies uniform light intensity), and operated in a power efficient way, some sophisticated circuit control techniques must be involved.

Please refer to FIG. 1, which illustrates a schematic diagram of a LED circuit 10 of the prior art. The LED circuit 10 consists of a power supply device 100, lighting modules LM_1˜LM_N and control devices CD_1˜CD_N. The power supply device 100 is utilized to provide a common voltage VIN_0 to the lighting modules LM_1˜LM_N to drive and light up the lighting modules LM_1˜LM_N. The lighting modules LM_1˜LM_N are controlled by the control devices CD_1˜CD_N, and each of the lighting modules LM_1˜LM_N consists of a number of LED devices connected in series, each lighting module is corresponding to a working voltage, and the working voltages of the lighting modules LM_1˜LM_N can be different. When the power supply device 100 provides a voltage VIN_0 greater than the working voltage of the lighting module LM_X, the lighting module LM_X can start to conduct current and produce light. However, since each of the lighting modules LM_1˜LM_N is independently controlled by one of the control devices CD_1˜CD_N, it is difficult to make the currents flowing through the lighting modules LM_1˜LM_N to be uniform. In order to improve and assure the uniformity of the current, a complex coordinating mechanism should be established to coordinate the control devices CD_1˜CDN and the cost is high.

Besides that, the N working voltages corresponding to the lighting modules LM_1˜LM_N could be different, but the voltage level of the provided voltage VIN_0 is shared by lighting modules LM_1˜LM_N is of fixed value; since the input voltage VIN_0 cannot be adjusted dynamically, the energy transfer efficiency (from the electrical energy to optical energy) of the LED circuit 10 can hardly be improved, and much energy can be wasted.

### SUMMARY OF THE INVENTION

Therefore, the main objective of the present invention is to provide a power source control method for an LED circuit, and the related control device and LED circuit.

The present invention discloses a power source control method for a multi-module light-emitting diode (LED) circuit, which comprises a plurality of lighting modules connected in parallel, and each lighting module comprises a plurality of LEDs connected in series, and the current control method comprising detecting a signal characteristics value according to a plurality of switching signals, being used for controlling the conduction of currents in the plurality of lighting modules; comparing the signal characteristics value with a pre-determined value to generate a comparing result; and outputting the comparing result to an external power supply device, such that the external power supply device can adjust the voltage level of an input voltage of the multi-module LED circuit according to the comparing result.

The present invention further discloses a power source control device for a multi-module light-emitting diode (LED) circuit, which comprises a plurality of lighting modules connected in parallel, and each lighting module comprises a plurality of LEDs connected in series, and the current control device comprising a detecting unit, for detecting a signal characteristics value according to a plurality of switching signals; a comparing unit, for comparing the signal characteristics value with a pre-determined value to generate a comparing result; and a transmitting unit, for outputting the comparing result to an external power supply device, such that the external power supply device can adjust the voltage level of an input voltage of the multi-module LED circuit according to the comparing result.

The present invention further discloses a light-emitting diode (LED) circuit, comprising a power supply device, for supplying an input voltage; a plurality of lighting modules, coupled to the power supply device, each lighting module comprises a plurality of LEDs connected in series; and an integrated control device, coupled to the power supply device and the plurality of lighting modules, comprising a driving device, coupled to the plurality of lighting modules, for outputting a plurality of switching signals to the plurality of lighting modules to control the current conducting in the plurality of lighting modules; and a power control device, coupled to the driving device, comprising a detecting unit, for detecting a signal characteristics value according to a plurality of switching signals; a comparing unit, for comparing the signal characteristics value with a pre-determined value to generate a comparing result; and a transmitting unit, for outputting the comparing result to an external power supply device, such that the external power supply device can adjust the voltage level of an input voltage of the multi-module LED circuit according to the comparing result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a LED circuit of the prior art.

FIG. 2 illustrates a schematic diagram of a LED circuit according to an embodiment of the present invention.

FIG. 3 illustrates a schematic diagram of a power control process according to an embodiment of the present invention.

FIG. 4 illustrates a schematic diagram of a power control device according to an embodiment of the present invention.

FIGS. 5A and 5B illustrate two schematic diagrams of LED circuit with a Bang-bang Structure according to an embodiment of the present invention.

FIGS. 6A and 6B illustrate two schematic diagrams of LED circuit with a Constant Off-time Structure according to an embodiment of the present invention.

FIG. 7 illustrates a schematic diagram of an LED circuit with a Buck Structure according to an embodiment of the present invention.

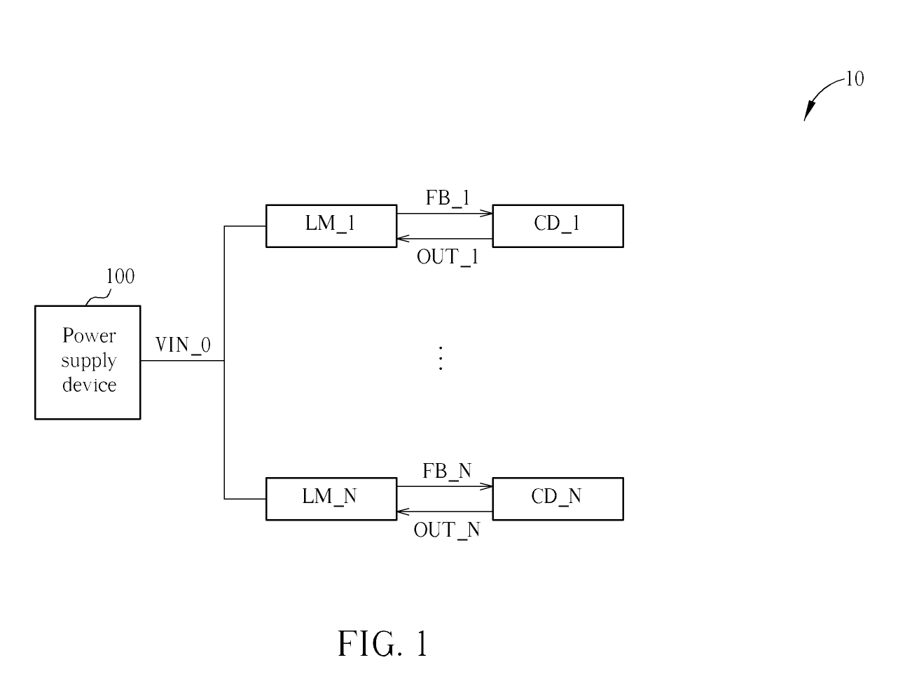

### DETAILED DESCRIPTION

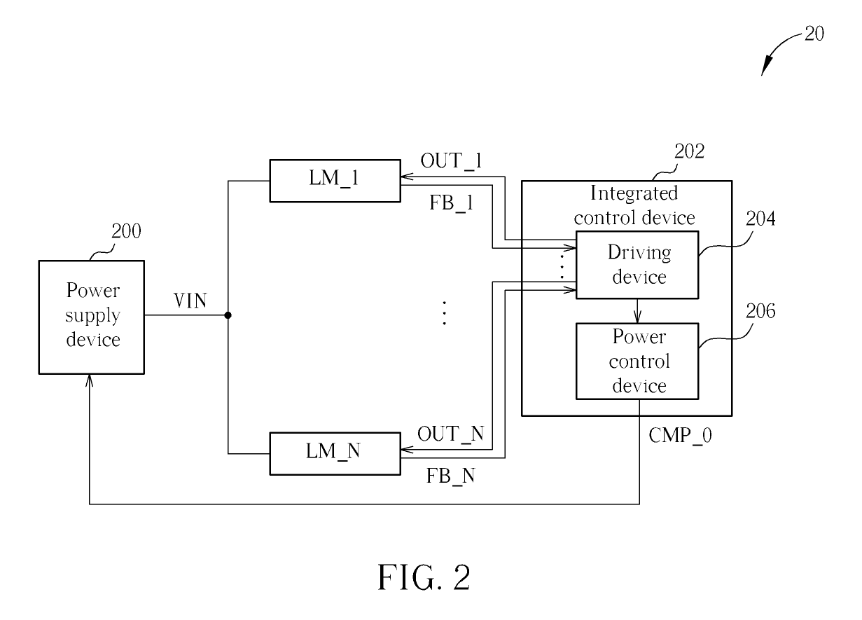

Please refer to FIG. 2, which illustrates a schematic diagram of a LED circuit 20 according to an embodiment of the present invention. The LED circuit 20 comprises a power supply device 200, lighting modules LM_1˜LM_N and an integrated control device 202. The power supply device 200 is utilized to provide an adjustable input voltage VIN to the lighting modules LM_1˜LM_N, and to drive the lighting modules LM_1˜LM_N to produce light. As depicted in FIG. 2, the lighting modules LM_1˜LM_N are connected in parallel, and preferably, each of the lighting modules LM_1˜LM_N comprises a number of LED devices connected in series. On the other hand, the integrated control device 202 is utilized to control the lighting modules LM_1˜LM_N, which comprises a driving device 204 and a power control device 206. Firstly, the driving device 204 is utilized to sense the current flowing through the lighting modules LM_1˜LM_N according to the feedback signals FB_1˜FB_N received in the feedback signal input ends, and then the driving device 204 is utilized to output switching signals OUT_1˜OUT_N, to control the current conductions in the lighting modules LM_1˜LM_N. Next, the power control device 206 is utilized to coordinate (by informing) the power supply device 300 to adjust the input voltage VIN according to the switching signals OUT_1˜OUT_N.

In the present invention, the control functions of the LED circuit 20 can be integrated into a compact integrated circuit by utilizing the circuit functions provided by the integrated control device 202; meanwhile, by coordinating the external power supply device 200 to provide an adjustable input voltage VIN, the (electrical to optical) power transfer efficiency of the lighting modules LM_1˜LM_N and the LED circuit 20 can be optimized.

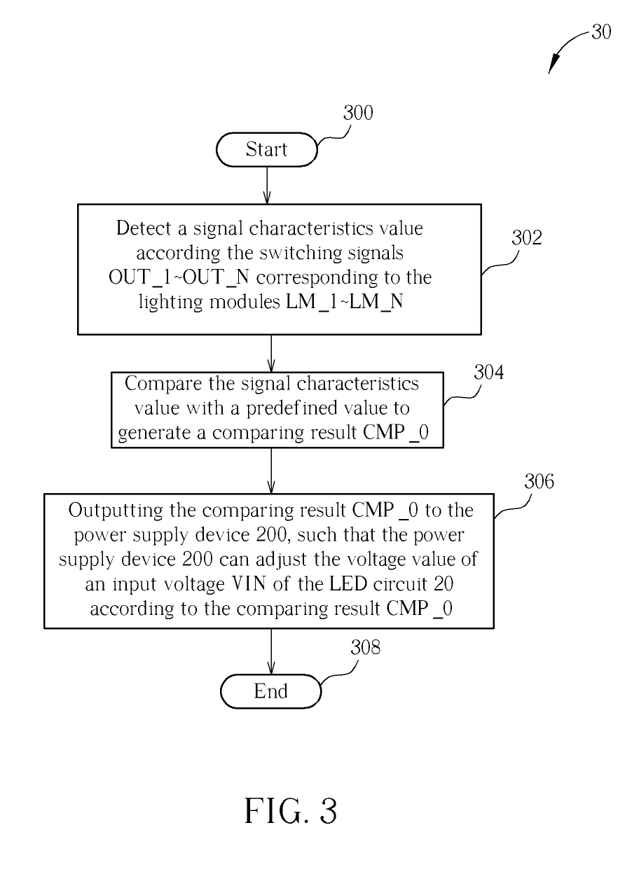

About the working principles of the integrated control device 202, please refer to FIG. 3, which illustrates a schematic diagram of a power control process 30. The power control process 30 comprises the following steps:

STEP 300: Start.

STEP 302: Detect a signal characteristics value according the switching signals OUT_1˜OUT_N corresponding to the lighting modules LM_1˜LM_N.

STEP 304: Compare the signal characteristics value with a predefined value to generate a comparing result CMP_0.

STEP 306: Outputting the comparing result CMP_0 to the power supply device 200, such that the power supply device 200 can adjust the voltage value of an input voltage VIN of the LED circuit 20 according to the comparing result CMP_0.

STEP 308: End.

According to the power control process 30, the present invention is to detect a signal characteristics value according the switching signals OUT_1˜OUT_N, which are utilized to control the lighting modules LM_1˜LM_N. After that, the signal characteristics value is to be compared with a predetermined value; then, the comparing result CMP_0 is outputted to the power supply device 200, such that the power supply device 200 can adjust the input voltage VIN of the LED circuit 20 according to the comparing result CMP_0. Generally speaking, when the voltage level of the input voltage VIN of the LED circuit 20 are getting closer to the working voltages of the lighting modules LM_1˜LM_N, the electro-to-optical energy transfer efficiency will become better. Therefore, in the present invention, the power control process 20 can adjust the input voltage VIN to an optimized voltage value by the comparing operation between the signal characteristics value and a predefined value, such that the power efficiency of the LED circuit 20 can reach to an optimal status.

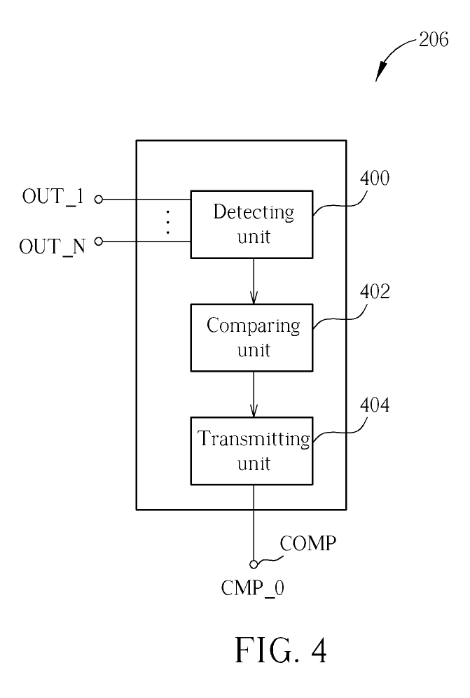

Please refer to FIG. 4, which illustrates a schematic diagram of a power control device 206 according to an embodiment of the present invention. The power control device 206 comprises a detecting unit 400, a comparing unit 402 and a transmitting unit 404. The detecting unit 400 is utilized to detect a signal characteristics value according to the switching signals OUT_1˜OUT_N of the lighting modules LM_1˜LM_N. The comparing unit 402 is utilized to compare the signal characteristics value with a predefined value, generate a comparing result CMP_0, and have the transmitting unit 404 output the comparing result CMP_0 to the power supply unit 200. After that, the power supply device 200 can adjust the voltage level of the input voltage VIN according to the comparing result CMP_0.

According to the embodiment of the present invention, the integrated control device 202 of the LED circuit 20 outputs the switching signals OUT_1˜OUT_N to control the current switching of the lighting modules LM_1˜LM_N. Meanwhile, the present invention utilizes the detecting unit 400, the comparing unit 402 and the transmitting unit 404, all belonging to the power control device 206, to coordinate the control (adjustment) of the input voltage VIN, such that the currents flowing through the lighting modules LM_1˜LM_N can be uniform or be balanced, and the electric power can be saved most. Preferably, the integrated control device 202 can be realized in a single integrated circuit (IC) chip, and the IC chip is utilized to control the balance of the currents of two or more lighting modules.

Besides that, according to the circuit architecture and the operating method of the embodiment of the present invention, the signal characteristics value and its corresponding predetermined value can have alternate meanings. To detail further, the control method of t the present invention can be applied in the Bang-bang Structure (also named as Hysterical Structure), the Constant Off-time Structure and the Buck Structure. Firstly, if the control method of the LED circuit 20 is to be utilized with the Bang-bang Structure, then, in the power control process 30, the signal characteristics value is specified as the minimum value of the duty-off times of the switching signals OUT_1˜OUT_N, and the corresponding predetermined value specified in STEP 304 will be a duty-off time reference value. In other words, by using the Bang-bang Structure, the power control process 30 will find out the minimum value of the duty-off time of all of the switching signals OUT_1˜OUT_N, and the minimum value of the duty-off time will be controlled to be equal to the duty-off time reference value. Secondly, if the control method of the LED circuit 20 is to utilize the Constant Off-time Structure, then the signal characteristics value is specified as the minimum value of the switching frequencies of all of the switching signals OUT_1˜OUT_N, and the corresponding predetermined value specified in STEP 304 will be a switching frequency reference value. In other words, by using the Constant Off-time Structure in the LED circuit 20, the power control process 30 will find out the minimum value of the switching frequency of the switching signals OUT_1˜OUT_N, and the minimum value of the switching frequency will be controlled to be equal to the switching frequency reference value. At last, if the control method of the LED circuit 20 is to utilize the Buck Structure, then the signal characteristics value is specified as the maximum value of the duty cycle while the switching frequencies of the switching signals OUT_1˜OUT_N are all equal, and the corresponding predetermined value specified in STEP 304 will be a duty cycle reference value. In other words, by using the Buck Structure in the LED circuit 20, the power control process 30 will find out the maximum value of the duty cycle of all of the switching signals OUT_1˜OUT_N, and the minimum value of the duty cycle will be controlled to be equal to the duty cycle reference value.

As stated above, the present invention can be applied to the Bang-bang Structure, the Constant Off-time Structure and the Buck Structure. In the following paragraphs, the architecture and the operating principles of these different embodiments are to be described in more detail.

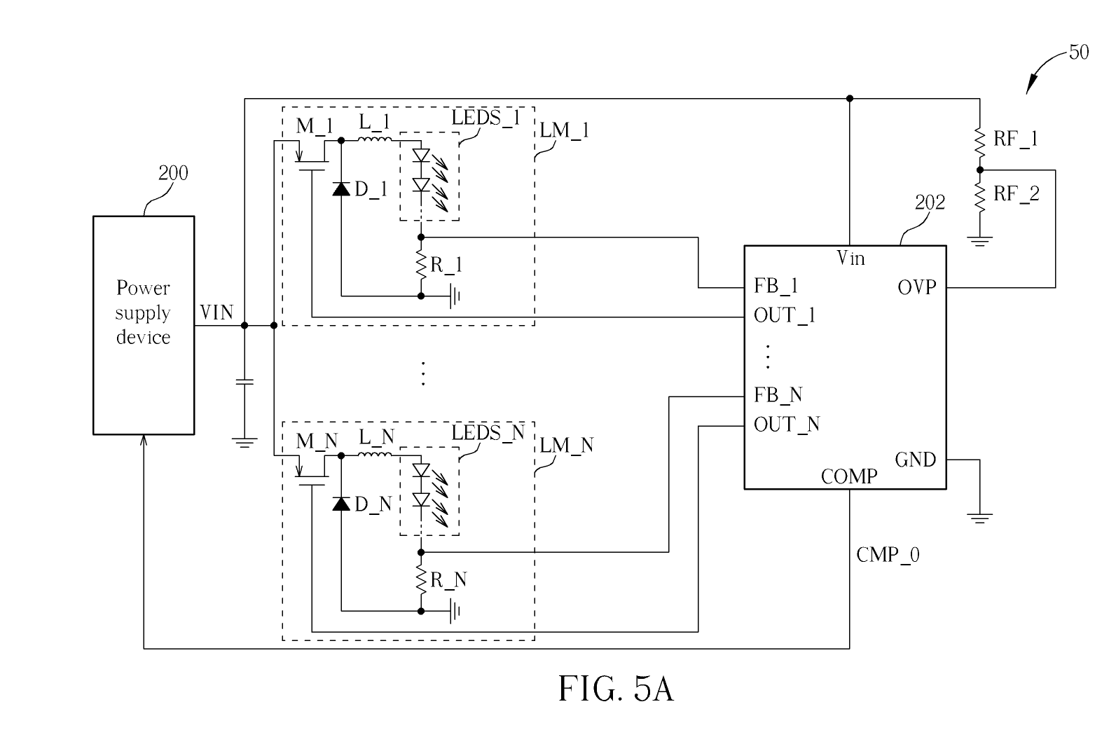

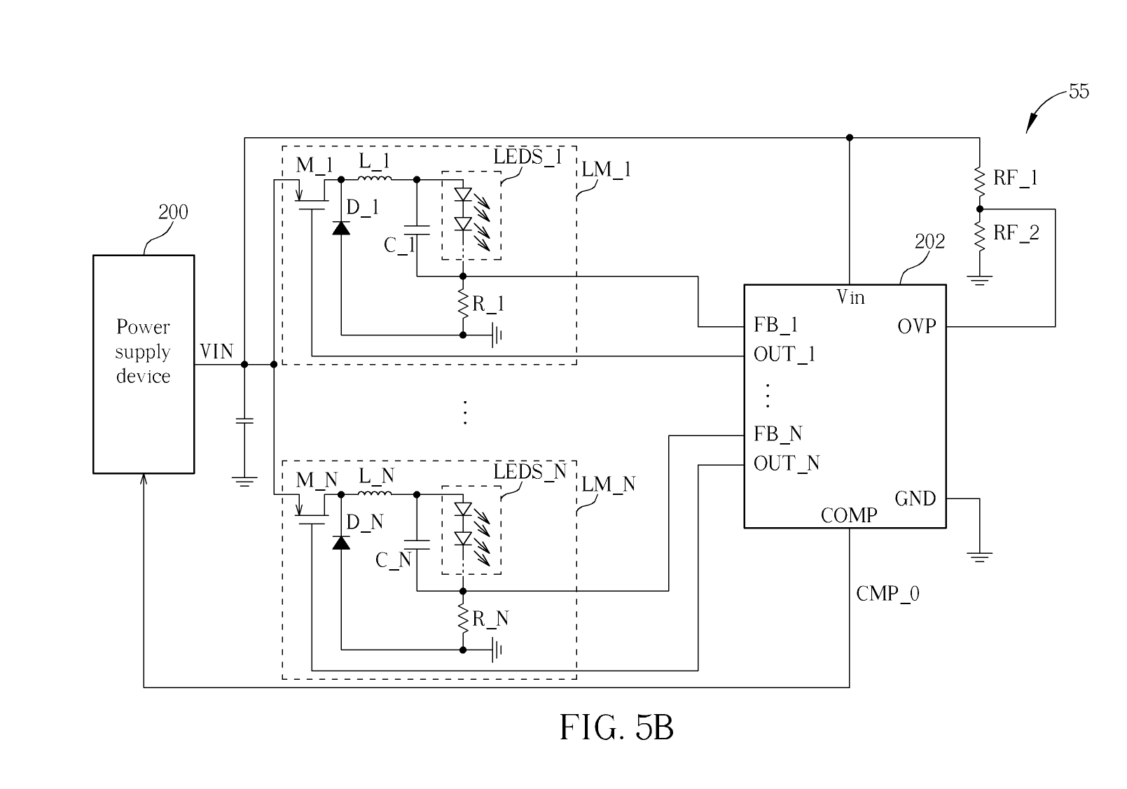

Please refer to FIG. 5A, which illustrates a schematic diagram of an LED circuit 50 using the Bang-bang Structure. As can be understood from FIG. 5A, the architecture of the LED circuit 50 is equivalent to that of the LED circuit 20, except more details of the lighting modules LM_1˜LM_N have been drawn. Inside that, the lighting modules LM_1˜LM_N comprise LED diodes series LEDS_1˜LEDS_N, module transistors M_1˜M_N, inductors L_1˜L_N, diodes D_1˜D_N and resistors R_1˜R_N. The LED circuit 50 utilizes the switching signals OUT_1˜OUT_N to control the switching on/off operations of each of the module transistors M_1˜M_N, such that the current flowing through each of the inductors L_1˜L_N can be controlled, and moving back and forth within a range pre-determined by an upper bound and an lower bound, and then the LED diodes series LEDS_1˜LEDS_N can be driven by proper operating voltages and currents. On the other hand, the diodes D_1˜D_N connected in parallel with the LED series LEDS_1˜LEDS_N is utilized to conduct current from the ground GND to the inductors L_1˜L_N while the module transistors M_1˜M_N are switched off. Noticeably, under the Bang-bang Structure, the energy charging speed will be faster, if the working voltage of the diode series is higher, and the energy charging speed will be slower, if the working voltage of the diode series is lower. In other words, for the same input voltage VIN, if the working voltage of the diode series VOUT_x is higher, the duty-on time tₒₙ of the switching signal OUT_x will be longer, and the corresponding duty-off time t_{off} will be shorter. On the contrary, if the working voltage of the diode series VOUT_x is smaller, the duty-on time tₒₙ of the switching signal OUT_x will be shorter, and the corresponding duty-off time t_{off} will be longer. According to the definition, the duty cycle D can be expressed as follows:

$$D = \frac{{t}_{on}}{{t}_{on} + {t}_{off}} .$$

In other words, if the voltage difference (or gap) between the input voltage VIN and a working voltage VOUT_x gets smaller, the duty-on time tₒₙ of the module transistor M x will get longer, and the duty-off time t_{off} will get shorter, and then the value of the duty cycle D will be closer to 1, and the energy transfer efficiency will be very well. Therefore, the LED circuit 50 can adjust the input voltage VIN to a lower value to make the duty cycle D closer to 1, such that the electrical-to-optical energy transfer efficiency can be higher. Or equivalently, decreasing the input voltage VIN can shorten the duty-off time t_{off}, and the electrical-to-optical energy transfer efficiency can be made higher. Therefore, according to an embodiment of the present invention, after determining the minimal value of the duty-off time t_{off} (among all the lighting modules LM_1˜LM_N) by detecting the module transistors M_1˜M_N in the Bang-bang Structure, the minimal value is then taken to be compared with a predetermined duty-off time reference value, such that a comparing result CMP_0 can be generated. Briefly speaking, the comparing result CMP_0 comes from finding out the minimum of the N duty-off times corresponding to the N module transistors M_1˜M_N, and comparing the minimum value with a pre-defined duty-off time reference value by checking which one is of a larger value. After that, the comparing result CMP_0 is transmitted to the power supply device 200 via an output end COMP, such that the power supply device 200 can adjust the voltage level of the input voltage VIN of the LED circuit 50 according to the comparing result CMP_0, and then the minimal duty-off time can be controlled to be approximately equal to the duty-off time reference value. Since the input voltage VIN is higher than the working voltage of any of the lighting modules LM_1˜LM_N, the lighting modules LM_1˜LM_N can produce light all right, and by adjusting the minimum of the N duty-off times to an specific operating point (the duty-off time reference value), the energy transfer efficiency can be optimized.

Besides that, the integrated control device 202 further comprises an over-voltage protection input end OVP for over-voltage protection, and feedback input ends FB_1˜FB_N for sensing the magnitude of current flowing through each of the lighting modules LM_1˜LM_N. Also, the resistors R_1˜R_N are utilized to transfer the magnitude of current levels in the lighting modules LM_1˜LM_N into voltage signals, and the resistors RF_1 and RF_2 are utilized to function as a voltage divider to divide the input voltage VIN and connected to the over-voltage protection input end OVP to protect the chip. The operations of these components should be readily understood by the people skilled in the art, and won't be detailed hereafter.

Briefly speaking, the Bang-bang Structure 50 is to control the currents through the LED series LEDS_1˜LEDS_N to be approximately equal to an ideal current level, and detect the length of duty-off time toff for every module transistors M_1˜M_N of the lighting modules LM_1˜LM_N, and the input voltage VIN is adjusted to a proper voltage level, such that the minimum of the duty-off time t_{off} is approximately equal to a predetermined duty-off time reference value. By doing this, the electro-to-optical energy transfer efficiency can be optimized.

Besides that, please refer to FIG. 5B, which illustrates a schematic diagram of an LED circuit 55 also using the Bang-bang Structure according to an alternative embodiment of the present invention. The LED circuit 55 is identical to the LED circuit 50, except numbers of bypass capacitors C_1˜C_N are connected in parallel with the LED series LEDS_1˜LEDS_N. One of the main objectives for adding the bypass capacitors C_1˜C_N is to let the signal components of higher frequency to go through the bypass capacitors C_1˜C_N, instead of the LED series LEDS_1˜LEDS_N. The operating principles of the rest of circuit components are identical to the LED circuit 50, as depicted in FIG. 5A, and won't be detailed further.

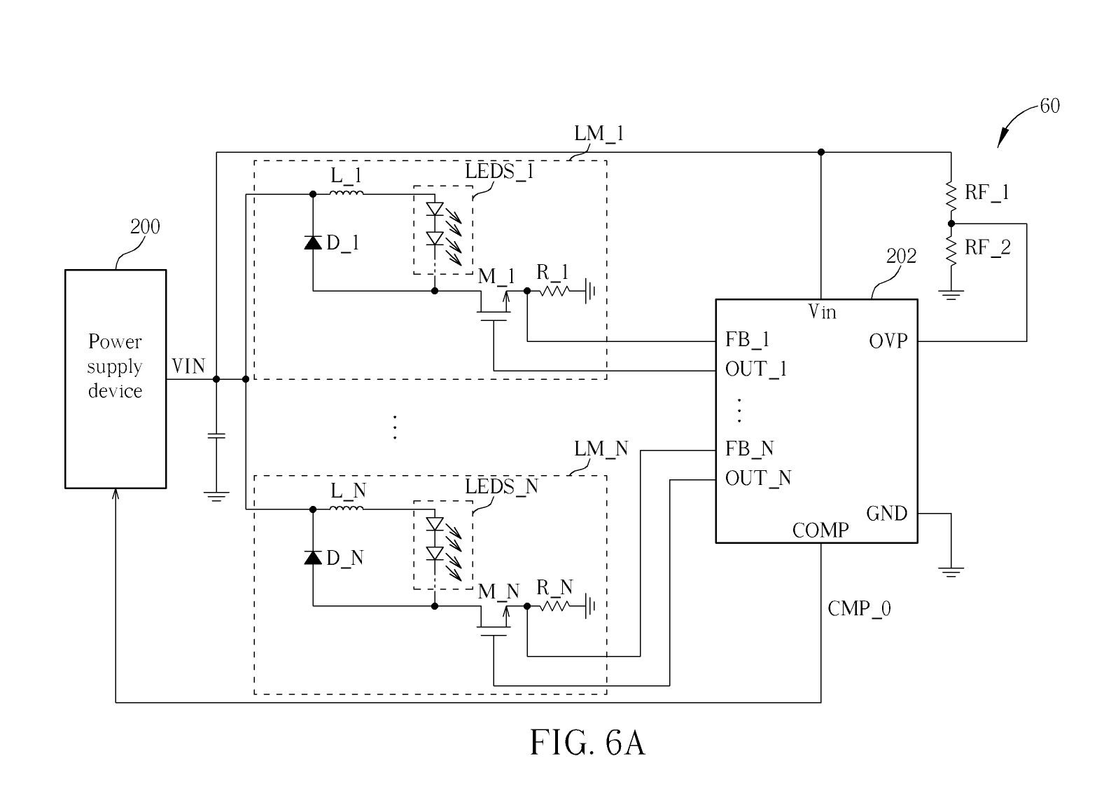

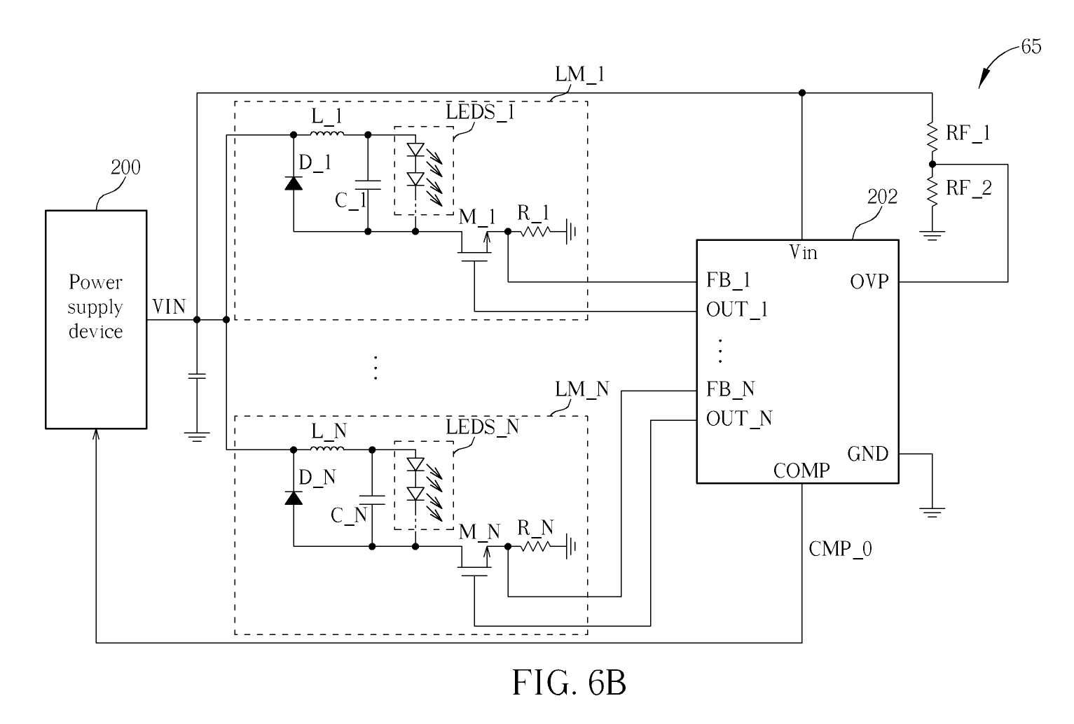

Please refer to FIG. 6A, which illustrates a schematic diagram of an LED circuit 60 using the Constant Off-time Structure. As can be understood from FIG. 6A, the architecture of the LED circuit 60 is equivalent to that of the LED circuit 20, except that the details of the lighting modules LM_1˜LM_N have been drawn. Inside FIG. 6A, the lighting modules LM_1˜LM_N comprise LED diodes series LEDS_1˜LEDS_N, module transistors M_1˜M_N, inductors L_1˜L_N, diodes D_1˜D_N and resistors R_1˜R_N. The LED circuit 60 utilizes the switching signals OUT_1˜OUT_N to control the switching operations of each of the module transistors M_1˜M_N, such that the LED diodes series LEDS_1˜LEDS_N can be driven by proper voltages and currents. However, differing from the Bang-bang Structure 50, 55, the Constant Off-time Structure 60 fixes the length of duty-off time t_{off} to a constant, and let only the duty-on time tₒₙ adjustable to provide the LED series with proper voltage and current. Since the switching period of each of the module transistors M_1˜M_N is equal to the summation of its duty-on time tₒₙ and duty-off time t_{off}, according to the operating principle, if the voltage difference between the input voltage VIN and any of the working voltage VOUT_x gets larger, the switching frequency of that module transistors will also get larger, and if the gap between the input voltage VIN and any of the working voltage VOUT_x gets smaller, the switching frequency of that module transistors will also get smaller. According this embodiment of the present invention, the Constant Off-time Structure detects the minimum of the switching frequencies of all of the module transistors M_1˜M_N, and the minimal switching frequency is then compared with a predetermined switching frequency reference value, and a comparing result CMP_0 will be generated. In this case, the comparing result CMP_0 is the result getting from comparing the minimum of the switching frequencies and the value of the switching frequency reference value. Finally, the integrated control device 202 transmits the comparing result CMP_0 to the power supply device 200, and the power supply device 200 can adjust the voltage level of the input voltage VIN according to the comparing result CMP_0, such that the minimum of the switching frequencies corresponding to the module transistors M_1˜M_N can be controlled to be equal to the switching frequency reference value. By doing this, every lighting module can produce light properly, and the electro-to-optical transfer efficiency can be optimized.

Briefly speaking, the LED circuit 60 with Constant Off-time Structure is utilized to control the currents through the LED series LEDS_1˜LEDS_N to be balanced and to be approximately equal to an ideal current level, and according to the switching frequency of each of the module transistors M_1˜M_N, the input voltage VIN is adjusted to a proper voltage level, such that the minimum of the switching frequencies is controlled to a predetermined switching frequency reference value. By doing this, the electro-to-optical energy transfer efficiency can be optimized.

Besides that, please refer to FIG. 6B, which illustrates a schematic diagram of an LED circuit 65 also with the Constant Off-time Structure according to an embodiment of the present invention. The LED circuit 65 is identical to the LED circuit 60, except bypass capacitors C_1˜C_N are connected in parallel with the LED series LEDS_1˜LEDS_N. One of the main objectives for the bypass capacitors C_1˜C_N is to let the higher frequency components of the signal to go through the bypass capacitors C_1˜C_N, instead of passing the LED series LEDS_1˜LEDS_N. The operating principles of the rest of circuit components are identical to the LED circuit 60, and won't be detailed further.

Noteworthily, the Constant Off-time Structure 60, 65 controls the minimal switching frequency of all the lighting modules, such that the minimal switching frequency can be greater than the audible frequency range of the human ears (ranged from 20 to 20,000 Hz), such that the operation of the LED circuit 60, 65 won't generate annoying noise to bother the user. Meanwhile, the Constant Off-time Structure 60, 65 can set and control the minimal switching frequency to some value according to any other relevant applications. Generally, when the input voltage VIN is adjusted to be closer to the maximal value of the working voltages VOUT_1˜VOUT_N, the electric-to-optical energy transfer efficiency will be better. For making the circuit simple, the present invention doesn't go straightforward and makes things complex by measuring the working voltages VOUT_1˜VOUT_N, and to decide the input voltage VIN according to the working voltages VOUT_1˜VOUT_N. On the contrary, the present invention determines a signal characteristics value according to some operating signal parameters, such as the switching frequencies, the duty-on times tₒₙ and the duty-off times t_{off} of each of the LED series LEDS_1˜LEDS_N, and applies the signal characteristics value to be the basis for judging, such that the input voltage VIN level can be properly adjusted. By using this effective method, the energy transfer efficiency can be greatly improved.

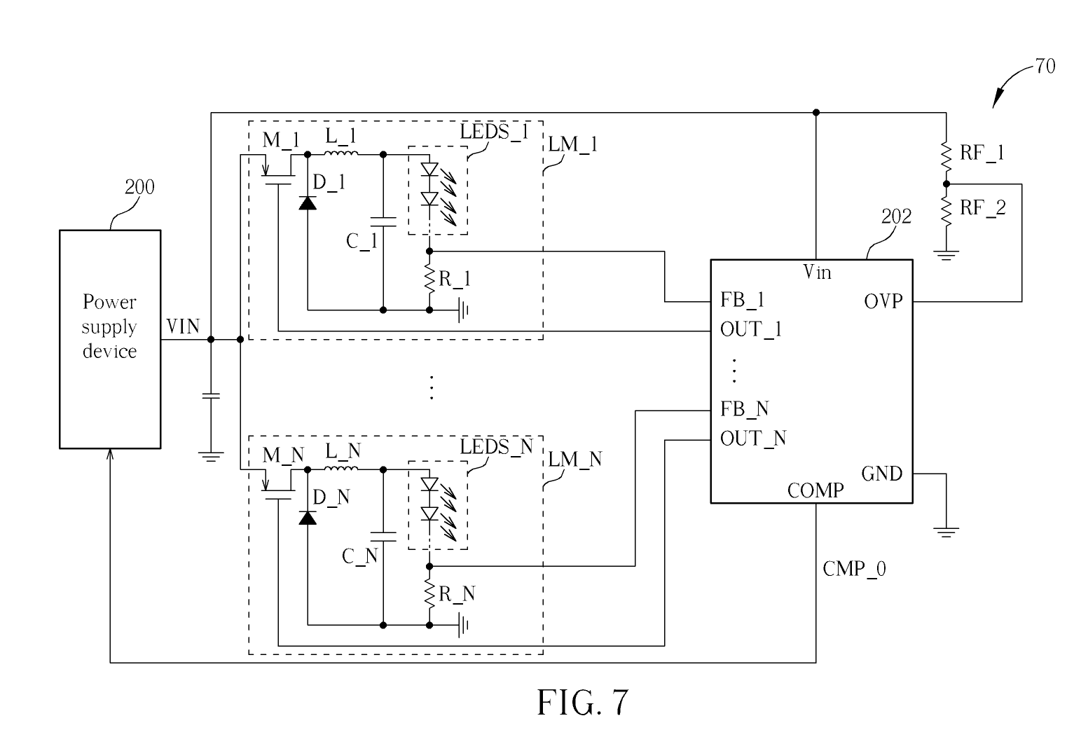

Please refer to FIG. 7, which illustrates a schematic diagram of an LED circuit 70 using the Buck Structure. As can be understood from FIG. 7, the architecture of the LED circuit 70 is equivalent to that of the LED circuit 20, except more details about the lighting modules LM_1˜LM_N have been drawn. Inside that, the lighting modules LM_1˜LM_N comprise LED diodes series LEDS_1˜LEDS_N, module transistors M_1˜M_N, inductors L_1˜L_N, diodes D_1˜D_N, capacitors C_1˜C_N and resistors R_1˜R_N. The LED circuit 70 utilizes the switching signals OUT_1˜OUT_N to control the switching operations of each of the module transistors M_1˜M_N, such that the LED diodes series LEDS_1˜LEDS_N can be driven by proper voltage and currents. The LED circuit 70 firstly controls the currents through the LED series LEDS_1˜LEDS_N to an ideal current level, and then detects the duty cycle of each of the module transistors M_1˜M_N. After the maximum of the duty cycle is detected, the present invention will compare the maximum of the duty cycles with a predetermined duty cycle reference value, and generates a comparing result CMP_0. Preferably, the switching periods (or the switching frequencies) of the module transistors M_1˜M_N are all equal. Noticeably, the comparing result CMP_0 comes from comparing the value of the maximal duty cycle and the duty cycle reference value. After that, the integrated control device 202 transmits the comparing result to the power supply device 200. The power supply device 200 can then adjust the input voltage VIN according to the comparing result CMP_0, such that the maximum of the duty cycles corresponding to the module transistors M_1˜M_N can be controlled to be equal to the duty cycle reference value.

Briefly speaking, the LED circuit 70 is utilized to control the currents through the LED series LEDS_1˜LEDS_N to be balanced and to be approximately equal to an ideal current level, and according to the duty cycle of each of the module transistors M_1˜M_N corresponding to the lighting modules LM_1˜LM_N, the input voltage VIN is adjusted to a proper voltage level, such that the maximum of the duty cycle is controlled to be equal to a predetermined value, which is the duty cycle reference value. By doing this, the electro-to-optical energy transfer efficiency can be optimized. Preferably, the duty cycle reference value can be a value between 0.97 and 1.0. Noticeably, the control method introduced above is actually a control method with more general usages, and can be applied to other types of LED circuit. In other words, the control method for the LED circuit 70 can also be applied for the LED circuits with the Bang-bang Structure or the Constant Off-time Structure.

Noteworthily, when the input voltage level of the LED circuit is closer to the working voltage VOUT_x of the LED series, the electrical-to-optical energy transfer efficiency can be better. In a LED circuit structure containing multiple lighting modules, and each lighting modules further containing multiple LEDs, the working voltage of each LED series can't be exactly equal, this then makes it very difficult to balance the light intensity (or currents) over all lighting modules and also keep the efficiency high. The present invention discloses numbers of embodiments, including the Bang-bang Structure, the Constant Off-time Structure, and the Buck Structure, all of them can be integrated into a single integrated circuit and applied to balance the light intensity over all lighting modules and keep the efficiency high. Noticeably, since the control method and the architecture of the present invention is very compact, so it can easily be realized by a single integrated circuit, and it becomes much easier to balance the current of those multiple lighting modules. After the currents of different lighting modules are balanced and adjusted to an ideal current level, the present invention determines a signal characteristics value according to the switching signals of the lighting modules; the signal characteristics value is then compared with a predetermined value to generate a comparing result; the comparing result is transmitted to an external voltage source whose output voltage level is being adjustable; at last, the common input voltage of the lighting modules is adjusted to an desired level, such that the LED circuit can be operated with optimal energy transfer efficiency.

To make a summary, the multi-module LED circuits of the present invention applies an integrated circuit to control a number of LED lighting modules, and to adjust the input voltage, such that the currents flowing in the LED lighting modules can be uniform, and the electrical-to-optical energy transfer efficiency can also be optimized.

Those skilled in the art will readily observe that numerous modifications and alterations of the device and method may be made while retaining the teachings of the invention.

What is claimed is:

1. A power source control method for a multi-module light-emitting diode (LED) circuit, the multi-module LED circuit comprising a plurality of lighting modules connected in parallel, each lighting module comprising a plurality of LEDs connected in series, the current control method comprising:
detecting a signal characteristics value according to a plurality of switching signals, being used for controlling the conduction of currents in the plurality of lighting modules;
comparing the signal characteristics value with a pre-determined value to generate a comparing result; and
outputting the comparing result to an external power supply device, such that the external power supply device can adjust the voltage level of an input voltage of the multi-module LED circuit according to the comparing result.

2. The power source control method of claim 1, wherein the voltage level of the input voltage is jointly used by the plurality of lighting modules.

3. The power source control method of claim 1, wherein the signal characteristics value is a duty-off time value of a switching signal whose duty-off time is the shortest among the plurality of switching signals.

4. The power source control method of claim 3, wherein the pre-determined value is a duty-off time reference value.

5. The power source control method of claim 1, wherein the signal characteristics value is a switching frequency value of a switching signal whose switching frequency is the lowest among the plurality of switching signals.

6. The power source control method of claim 5, wherein the pre-determined value is a switching frequency reference value.

7. The power source control method of claim 1, wherein the signal characteristics value is a duty cycle value of a switching signal whose duty cycle is the longest among the plurality of switching signals.

8. The power source control method of claim 7, wherein the pre-determined value is a duty cycle reference value.

9. The power source control method of claim 1, wherein the said the external power supply device can adjust the voltage level of the input voltage of the multi-module LED circuit according to the comparing result is to transmit the comparing result, and adjust the voltage level of the input voltage via a feedback input end of the external power supply device.

10. A power source control device for a multi-module light-emitting diode (LED) circuit, the multi-module LED circuit comprising a plurality of lighting modules connected in parallel, each lighting module comprising a plurality of LEDs connected in series, the current control device comprising:
a detecting unit, for detecting a signal characteristics value according to a plurality of switching signals;
a comparing unit, for comparing the signal characteristics value with a pre-determined value to generate a comparing result; and
a transmitting unit, for outputting the comparing result to an external power supply device, such that the external power supply device can adjust the voltage level of an input voltage of the multi-module LED circuit according to the comparing result.

11. The power source control device of claim 10, wherein the voltage level of the input voltage is jointly used by the plurality of lighting modules.

12. The power source control device of claim 10, wherein the signal characteristics value is a duty-off time value of a switching signal whose duty-off time is the shortest among the plurality of switching signals.

13. The power source control device of claim 12, wherein the pre-determined value is a duty-off time reference value.

14. The power source control device of claim 10, wherein the signal characteristics value is a switching frequency value of a switching signal whose switching frequency is the lowest among the plurality of switching signals.

15. The power source control device of claim 14, wherein the pre-determined value is a switching frequency reference value.

16. The power source control device of claim 10, wherein the signal characteristics value is a duty cycle value of a switching signal whose duty cycle is the longest among the plurality of switching signals.

17. The power source control device of claim 16, wherein the pre-determined value is a duty cycle reference value.

18. The power source control device of claim 10, wherein the transmitting device is to transmit the comparing result, and adjust the voltage level of the input voltage via a feedback input end of the external power supply device.

19. a light-emitting diode (LED) circuit, comprising:
a power supply device, for supplying an input voltage;
a plurality of lighting modules, coupled to the power supply device, each lighting module comprising a plurality of LEDs connected in series; and
an integrated control device, coupled to the power supply device and the plurality of lighting modules, comprising:
a driving device, coupled to the plurality of lighting modules, for outputting a plurality of switching signals to the plurality of lighting modules to control the current conducting in the plurality of lighting modules; and
a power control device, coupled to the driving device, comprising:
a detecting unit, for detecting a signal characteristics value according to a plurality of switching signals;
a comparing unit, for comparing the signal characteristics value with a pre-determined value to generate a comparing result; and
a transmitting unit, for outputting the comparing result to an external power supply device, such that the external power supply device can adjust the voltage level of an input voltage of the multi-module LED circuit according to the comparing result.

20. The LED circuit of claim 19, wherein the voltage level of the input voltage is jointly used by the plurality of lighting modules.

21. The LED circuit of claim 19, wherein the signal characteristics value is a duty-off time value of a switching signal whose duty-off time is the shortest among the plurality of switching signals.

22. The LED circuit of claim 21, wherein the pre-determined value is a duty-off time reference value.

23. The LED circuit of claim 19, wherein the signal characteristics value is a switching frequency value of a switching signal whose switching frequency is the lowest among the plurality of switching signals.

24. The LED circuit of claim 23, wherein the pre-determined value is a switching frequency reference value.

25. The LED circuit of claim 19, wherein the signal characteristics value is a duty cycle value of a switching signal whose duty cycle is the longest among the plurality of switching signals.

26. The LED circuit of claim 25, wherein the pre-determined value is a duty cycle reference value.

27. The LED circuit of claim 19, wherein the transmitting device is to transmit the comparing result, and adjust the voltage level of the input voltage via a feedback input end of the external power supply device.
